(19) United States
(12) Patent Application Publication
(10) Pub. No.: US 2010/0186287 A1
(43) Pub. Date: Jul. 29, 2010

(54) Fuel Apparatus and Method

(76) Inventors: David Wheeler, Beaverton, OR (US); Nora Kosztolanyi, Beaverton, OR (US)

Correspondence Address: BERT P. KRAGES II;ATTORNEY AT LAW, 6665 SW HAMPTON ST, PORTLAND, OR, 97223, US

(21) Appl. No.: 12/664,697

(22) PCT Filed: Jun. 25, 2008
(86) PCT No.: PCT/US08/68158

§ 371 Date: Dec. 15, 2009

Related U.S. Application Data
(60) Provisional application No. 60/946,638, filed on Jun. 27, 2007.

(51) Int. Cl. C10L 1/10; B01J 19/00

(52) U.S. Cl. 44/300; 422/129

(57) ABSTRACT

An apparatus and method of enhancing fuel combustion by organizing an amount of transformed water with a high level of stored energy into a geometric arrangement such that a central cavity is created that substantially surrounds a segment of a fuel line leading to a combustion device such as an internal combustion engine. The fuel passes within the space surrounded by the transformed water and becomes imprinted with a molecular clustering as a result of water memory transfer at a lower level of stored energy. This process alter the properties of the fuel allowing it to be utilized with a higher level of efficiency and with lower emissions of pollutants such as hydrocarbons and carbon monoxide.

### FIELD OF THE INVENTION

The invention relates generally to an apparatus and method for modifying carbon-based fuels to enhance fuel efficiency and reduce combustion emissions.

### BACKGROUND OF THE INVENTION

The basic functioning of the invention is believed to be due to the memory-imprinting ability of various forms of water to affect way that molecules associate with one another. Water is composed of molecules consisting of two hydrogen atoms that are covalently attached to an oxygen atom in the form of a polar bond. The polar bonds are characterized by a small localized negative charge around the oxygen atom and a small localized positive charge around the hydrogen atoms. These partial charges enable water molecules to bind up with other water molecules in ways that can result in various lattice arrangements. Once a form of hydrogen bonding has occurred, the redistribution of electrons alters the ability for further hydrogen bonding. Under proper conditions, the water molecules will associate themselves into small clusters that behave differently in many ways from molecules in the bulk water form such as commonly exists in tap water.

There are various means of inducing water molecules to arrange themselves into small clusters that possess particular properties such as frequency and electromagnetic resonance. Such means include the application of concussive forces that may include vortex motion, the addition of minerals and solids, the addition of gases, ionization, contact with electricity, and the application of strong or weak magnetic forces. Properly done, such means can produce water clusters that have specific frequencies and stabilities. This form of water thus produced is called transformed water.

One form of such clusters has a closed icosahedral symmetry formed by twenty hydrogen-bonded water molecules, also known as a dodecahedral water cluster. However, there are other forms of clustered water in which the clusters may be smaller or larger. Such clusters can be made to possess a stable structure with a water transfer memory property that can cause other molecules to respectively align themselves in specific ways.

Molecular memory transfer is defined as the capacity of molecules to alter their arrangement relative to each other when exposed to the specific structure and frequency of other water molecules. One means of transferring water memory to a collection of molecules is to add a batch of transformed water. This will result in the untransformed molecules restructuring their arrangement to a transform state with specific molecular cluster properties. Water memory can also be transferred by electromagnetic molecular signaling to likewise convert untransformed molecules into the transformed state. J. Benveniste, J. Nissa and D. Guillonnet, A Simple and Fast Method for in Vivo Demonstration of Electromagnetic Molecular Signaling (EMS) via High Dilution or Computer Recording, FASEB Journal, 1999, vol. 13, p. A163.

Fuel can be enhanced by exposure to transformed water to burn more efficiently and with lower emissions. The exact mechanism for such enhancement is beyond current analytical technology to ascertain because the modifications in structuring of the molecules are taking place at the nano level. Nonetheless, several molecular chemical models exist that may explain the causes underlying this phenomenon. One possibility is that the transformed water in the fuel device affects the structure of the fuel molecules such that they burn more efficiently in the presence of oxygen. The combustion of enhanced fuel may also result in the water formed during the combustion process having a higher energy nature based on a clustered structure.

Another possibility is that the memory transfer induces the formation of nanobubbles in the fuel. If nanobubbles are being created that are very small, such as the 2 to 3 nanometer range, memory transfer could achieve both molecular geometry changes as well as the formation of nanobubbles on a molecular level of size. This is particularly true when considering the flow through a fuel line, where air and water are trace constituents of the fuel. The enhancement of fuel as it is traveling through a line could be affected such that air is structured into nanobubbles and microclusters of water are formed within the fuel.

### SUMMARY OF THE INVENTION

The present invention provides an apparatus and method of enhancing fuel combustion by organizing an amount of transformed water with a high level of stored energy into a geometric arrangement such that a central cavity is created that substantially surrounds a segment of a fuel line leading to a combustion device such as an internal combustion engine. The fuel passes within the space surrounded by the transformed water and becomes imprinted with a molecular clustering as a result of water memory transfer at a lower level of stored energy. This process alter the combustion properties of the fuel allowing it to be utilized with a higher level of efficiency and with lower emissions of pollutants such as hydrocarbons and carbon monoxide.

It is contemplated that the invention will be most commonly operated in a continuous-flow version but it could also be adapted to operate in a static version to enhance fuels that are stored in vessels such as tanks, cans, jars, bottles, canisters, and bowls. In a static version, the fuel is placed within a vessel which is inserted into the central cavity surrounded by transformed water for a requisite time. This manner of operation allows for the making of enhanced fuel on a batch basis and is particular useful for enhancing fuel that is stored in standardized vessels such as propane or butane canisters. In a continuous-flow version, the fuel line is encased by the apparatus such that the fuel line runs through the central cavity. Fuel is conveyed through the pipe from a proximal end of the central cavity to the distal end, at a flow rate that ensures that the residence time of the water within the space defined by the central cavity is sufficient to ensure a memory-imprinting effect. The fuel is transformed during its passage through the section of fuel line encompassed by the central cavity and thus converted into an enhanced state by the time it exits the pipe at the distal end of the central cavity.

Testing of a prototype device has demonstrated that it is capable of improving fuel economy and emissions. Testing at a emissions facility in California showed the prototype device constructed in the manner of the preferred embodiment described below had a generally positive effect on air emissions from the engine. Three series of tests were performed on a 2005 Chevrolet Tahoe with and without the device installed over the fuel line. Substantial reductions of hydrocarbon and carbon monoxide emissions were observed as shown in table 1.

TABLE 1
Emission Reductions from Gasoline Engine

| | Total | Carbon | Nonmethane |
|---|---|---|---|
| | Hydrocarbons | Monoxide | Hydrocarbons |
| | (grams/mile) | (grams/mile) | (grams/mile) |
| mean with device | 0.109 | 1.485 | 0.092 |
| mean without device | 0.131 | 1.648 | 0.115 |
| % Difference | −17.3 | −9.9 | −19.7 |

Compilation of tests shown in table 2 conducted with passenger vehicles over duplicate courses demonstrated improvements in fuel economy when the device was installed on the vehicle fuel line.

TABLE 2
Fuel Efficiency Improvements - Gasoline Engine Vehicles

| | | | Fuel | Fuel | |
|---|---|---|---|---|---|
| | | | Efficiency | Efficiency | Increase in |
| | | | without device | with device | Efficiency |
| Vehicle | Engine | Course | (miles/gallon) | (miles/gallon) | (%) |
| 2007 Buick | 3.5 liter | Upland, CA to | 25.25 | 26.40 | 4.6 |
| Rendezvous | 6 cylinder | Palm Springs, | | | |
| | | CA round trip, | | | |
| | | 145.2 miles | | | |
| 2004 GMC | 3.5 liter | Upland, CA to | 26.71 | 30.98 | 16.0 |
| Canyon | 6 cylinder | Pasadena, CA | | | |
| Pickup | | round trip, | | | |
| (extended | | slightly over | | | |
| cab) | | 100 miles | | | |

Another test shows that the device is capable of improving fuel economy when applied to diesel fuel. The test was conducted in a 70-foot vessel fitted with twin Detroit engines. The vessel traveled under engine power from San Pedro Harbor to Catalina Island in California, a distance of about 26 miles. One of the engines received fuel from a fuel line on which the device was installed while the other engine was received fuel from a fuel line without the device. The improvement in fuel efficiency experienced by the engine using fuel enhanced by the device is shown in table 3.

TABLE 3
Fuel Consumption in Diesel Engines

| Fuel Usage in Engine | Fuel Usage in Engine | |
|---|---|---|
| without Device | with Device | Percent |
| (gallons) | (gallons) | Difference |
| 65 | 60 | 8.33 |

Evaluation of gasoline and diesel by the use of nuclear magnetic resonance spectroscopy (NMR) indicates that a change in the structure of the fuels occurs once they undergo activation by the device. The tables below reflect NMR data conducted on samples of fuels with and without activation by the device.

Hydrogen NMR Gasoline Integral Number Comparison

| | | |
|---|---|---|
| Activated | Non-Activated | Difference (%) |

Activated versus Non-Activated Aromatic Integral Frequency Number

| | | |
|---|---|---|
| 16.21 | 15.71 | 3.3 |

Activated versus Non-Activated Hydrocarbon Integral Frequency
Numbers

| | | |
|---|---|---|
| 123.52 | 125.21 | −1.6 |
| 247.82 | 246.80 | 0.4 |
| 342.7 | 345.14 | −0.7 |

Hydrogen NMR Diesel Integral Number Comparison
Activated versus Non-Activated Hydrocarbon Integral Frequency
Numbers

| Activated | Non-Activated | Difference (%) |
|---|---|---|
| 634.79 | 632.71 | 0.3 |
| 1245.28 | 1251.52 | −0.6 |
| 2071.10 | 2075.36 | −0.2 |

### DESCRIPTION OF DRAWINGS

FIG. 1 is an assembled perspective view of the invention in a continuous flow version.

FIG. 2 is an exploded perspective view of the invention in a continuous flow version.

FIG. 3 is a top view of the invention in a continuous flow version.

### DESCRIPTION OF THE PREFERRED EMBODIMENT

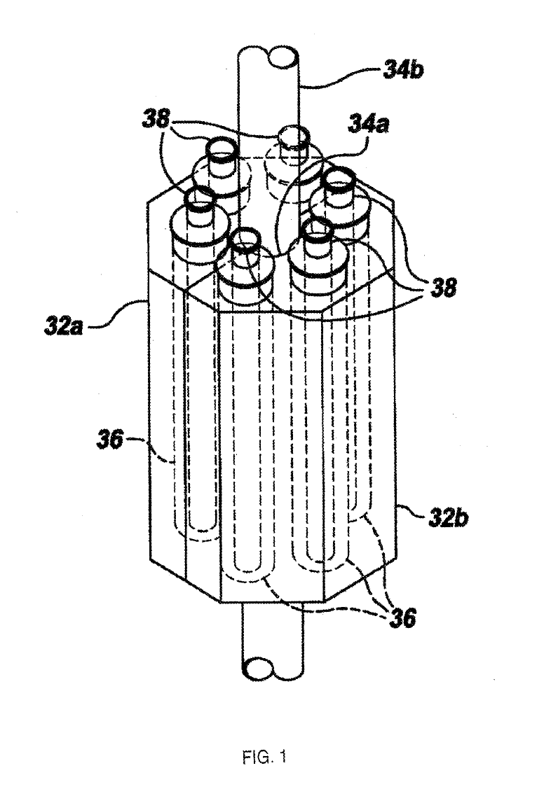

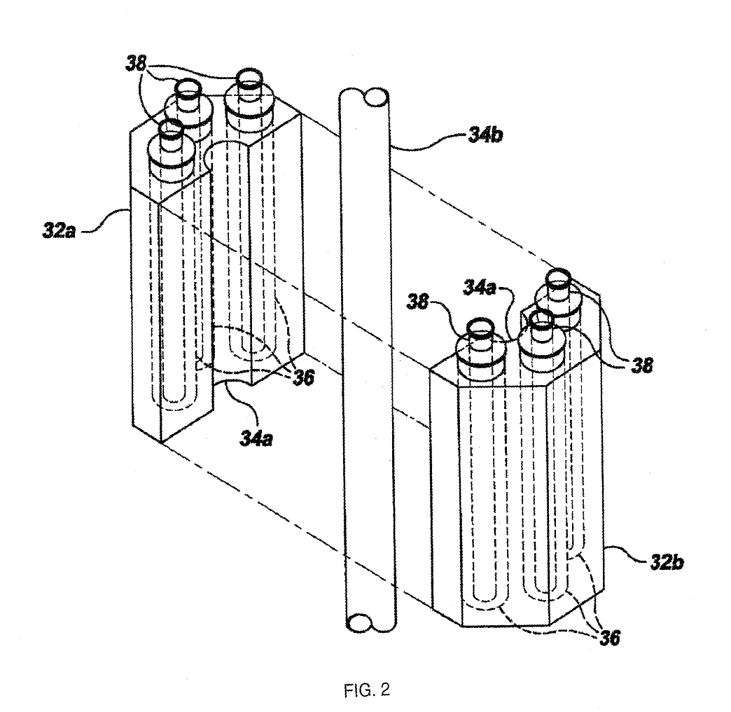

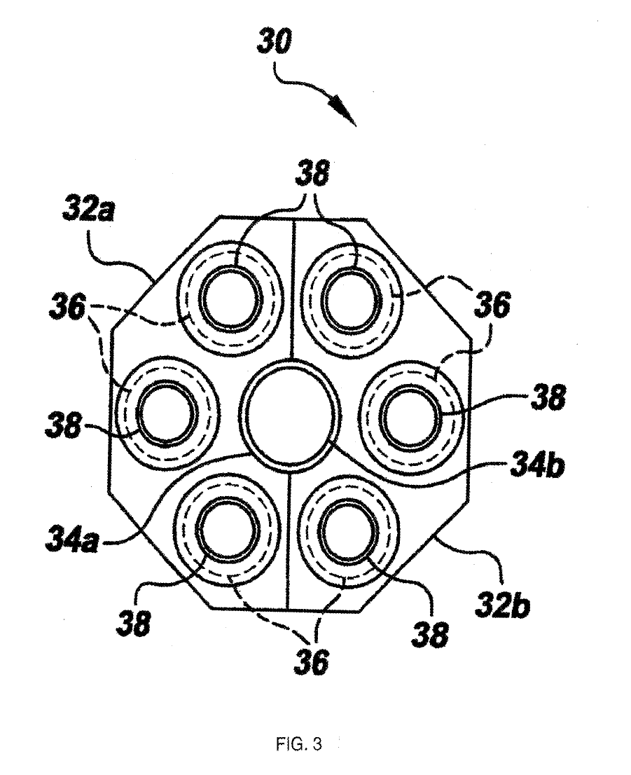

FIG. 1, FIG. 2, and FIG. 3 show the overall invention 30 in an embodiment that allows for fuel to be enhanced while flowing through a fuel pipe between a fuel tank and a combustion device such as an internal combustion engine. In the preferred embodiment, three substantially-cylindrical containers 36 are disposed in one half of a hexagonal shell 32a such that they substantially form a semicircle. Three other substantially-cylindrical containers are further disposed in an opposing half of a hexagonal shell 32b such that they substantially form a semicircle oriented in the opposite direction of the semicircular shape associated with shell 32a.

A central cavity 34a is formed when the shells 32a and 32b are brought together as shown in FIG. 1 and FIG. 2. When the shells 32a and 32b are brought together and secured over a fuel line 34b, the central cavity 34a will encompass said pipe and situate it in close proximity to the containers 36.

To enhance the fuel in fuel line 34b, the first step in the preferred embodiment is pour transformed water into the cylindrical containers 36 through open orifices 38 located at the topside ends of said containers. The orifices can then be sealed by means such as stoppers, caps, or lids. The next step is to bring the shells 32a and 32b together to encompass the fuel 34b inside the central cavity 34a. The shells by secured by means well known in the art such as clamping them around the fuel pipe by securing the halves together using bolts. Fuel is then brought to flow through the pipe 34b at a flow rate sufficient to ensure that residence time of the fuel within the section of pipe 34b encompassed by the central cavity 34a is sufficient to achieve an enhancement effect. The fuel will be enhanced during the time it resides within the section of fuel line 34b encompassed by the central cavity 32a, and be completely transformed upon exiting such section of pipe. Means of inducing and controlling flow within fuel line 34b are well known in the art and include pumps. gravity, valves, and petcocks. It should also be noted that alternative embodiments could use containers 36 in various arrangements comprising one or more containers of transformed watert.

The residence time of the fuel in section of fuel line encompassed by the device will depend on several factors including the nature of the fuel, the amount and energy level of the transformed water, the arrangement of the containers 36 around the fuel line 34b, the diameter of the fuel line or section surrounded by the containers, and the degree of desired enhancement of the fuel. An appropriate residence time can be readily determined through experimentation. For example, fuel can be run through a particular set-up comprising a known diameter of fuel line and the fuel efficiency and emissions of the combustion device measured during the period that fuel is flowing through the apparatus. The data obtained from the measurements can be used to make necessary adjustments in the parameters affecting fuel enhancement. For example, the residence time could be increased, if necessary, by means such as increasing the diameter of the section of fuel line passing through the apparatus. increasing the length of the apparatus, or increasing the energy level of the transformed water.

A static version of the fuel apparatus can be practiced as an alternative embodiment by placing three substantially-cylindrical containers 36 are disposed in one half of a hexagonal shell 32a such that they substantially form a semicircle. Three other substantially-cylindrical containers are further disposed in an opposing half of a hexagonal shell 32b such that they substantially form a semicircle oriented in the opposite direction of the semicircular shape associated with shell 32a. Once the hexagonal shells are placed together, a central cavity 34a is formed. A vessel containing the fuel. such as a gasoline can or propane cannister, is placed into the central cavity 34a for the requisite time to effect the change of the fuel to an enhanced state.

Those of ordinary skill in the art will recognize that the foregoing descriptions cover certain preferred embodiments of the invention. Various modifications can be made to the particular embodiments described without departing from the spirit and scope of the invention. For example, the cylinders 35 could be positioned around a flow-through chamber with and entrance end and an exit end such that the entrance end is attached to the end of a fuel line coming from a fuel tank and the exit end is attached to the end of fuel line going to an engine. This would allow for the incorporation of a flow-though chamber of sufficient length and diameter to ensure that an adequate residence time is provided for a specific application such as a particular model and variant of automobile. All such changes and modifications are considered be encompassed by the invention.

What is claimed is:

1. An apparatus for enhancing fuel quality comprising a carbon-based fuel and a means to place said fuel within a central cavity surrounded by transformed water.

2. The apparatus of claim 1 wherein said means is a vessel.

3. The apparatus of claim 1 wherein said means is a fuel pipe.

4. The apparatus of claim 1 wherein said transformed water is contained in two or more containers disposed radially around said central cavity.

5. The apparatus of claim 1 wherein said means is a fuel pipe and said transformed water is contained in two or more containers disposed radially around said central cavity.

6. A method for enhancing fuel quality comprising a placement step of placing a carbon-based fuel within a central cavity surrounded by transformed water for an amount of time effective to enhance the fuel efficiency of said fuel.

7. The method of claim 6 further comprising a containerizing step in which said fuel is a placed into a container during said placement step.

8. The method of claim 6 further comprising a fuel pipe disposed within said central cavity and in which said placement step comprises the flow of said fuel through said pipe.

9. The method of claim 7 wherein said transformed water is contained in two or more containers disposed radially around said central cavity.

10. The method of claim 8 wherein said transformed water is contained in two or more containers disposed radially around said central cavity.
